(19) United States
(12) Patent Application Publication
(10) Pub. No.: US 2009/0295857 A1
(43) Pub. Date: Dec. 3, 2009

(54) INK JET PRINTING APPARATUS

(75) Inventors: Noriyuki Kikuchi, Mishima-shi (JP); Jun Takamura, Mishima-shi (JP); Noboru Nitta, Tagata-gun (JP); Takanori Gomi, Numazu-shi (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/472,604

(22) Filed: May 27, 2009

Related U.S. Application Data
(60) Provisional application No. 61/056,539, filed on May 28, 2008.
(60) Provisional application No. 61/056,559, filed on May 28, 2008.
(60) Provisional application No. 61/056,566, filed on May 28, 2008.
(60) Provisional application No. 61/056,573, filed on May 28, 2008.

(51) Int. Cl. B41J 29/38; B41J 2/01

(52) U.S. Cl. 347/16; 347/102

(57) ABSTRACT

An ink jet printing apparatus includes a table which places a print medium on, a switching unit which switches the print medium to a fixed state or a released state with respect to the table, a carrying unit which carries the table, at least one or more print heads which eject ultraviolet curable ink, a first UV curing unit which is provided downstream from each of the print heads along a direction of carrying the table from an initial position toward the print heads and casts ultraviolet rays to provisionally cure the ultraviolet curable ink, and a second UV curing unit which is provided downstream from the first UV curing unit provided on the most downstream side along the direction of carrying the table from the initial position toward the print heads and casts ultraviolet rays to fully cure the ultraviolet curable ink.

### CROSS-REFERENCE TO RELATED APPLICATION

This application claims the benefit of U.S. Provisional Applications No. 61/056,566, filed on May 28, 2008, No. 61/056,573, filed on May 28, 2008, No. 61/056,539, filed on May 28, 2008 and No. 61/056,559, filed on May 28, 2008.

### TECHNICAL FIELD

The present invention relates to an ink jet printing technique using ultraviolet curable ink.

### BACKGROUND

Conventionally, an ink jet printing apparatus is developed which prints on a print medium that does not allow ink penetration such as thick paper or card (referred to as a non-penetrable medium). As shown in FIG. 22, in the conventional ink jet printing apparatus, a print head unit prints on a print medium set on a conveyor belt. The print medium with an image printed thereon falls by its own weight from an edge of the conveyor belt into a collection box provided downstream in the carrying direction of the print medium. Consequently, the collection box stores print media with images printed thereon, one after another.

The print head unit has four heads which eject ink of four colors, C, M, Y and K, along the carrying direction. The print head unit prints a full-color image on a print medium.

Normally, the ink jet printing apparatus is used for printing an image on a print medium that can be penetrated by ink, such as normal paper. In the print medium with an image printed thereon, the ink penetrates the print medium. Therefore, the ink does not remain on the surface of the print medium.

Meanwhile, the ink jet printing apparatus prints an image on a non-penetrable medium, the ink does not penetrate the print medium. Therefore, the ink remains on the surface of the non-penetrable medium. Thus, in the case of printing on a non-penetrable medium, the ink jet printing apparatus uses UV ink that becomes fixed even on the non-penetrable medium when irradiated with ultraviolet rays. However, UV ink does not immediately become fixed on the surface of the non-penetrable medium unless sufficiently irradiated with ultraviolet rays.

The conventional ink jet printing apparatus also has the following problems.

If the ink jet printing apparatus prints a full-color image on a non-penetrable medium by using ink of four colors, the image quality changes depending on the order of superimposition of the colors.

Since the conveyor belt has low accuracy in carrying a non-penetrable medium, the accuracy of image printing by the print head unit is lowered, too.

The collection box stores all the non-penetrable media irrespective of whether image printing is normally carried out or not. The user must select normal non-penetrable media from the collection box. This lowers work efficiency and productivity.

Before being carried to the printing position, plural non-penetrable media are superimposed and loaded on a card setting table. Therefore, the surface of the non-penetrable media becomes charged. Thus, there is a problem of degraded quality of images printed on the non-penetrable media.

The invention provides an ink jet printing apparatus which improves the quality of an image printed on a print medium.

### SUMMARY

According to an aspect of the present invention, there is provided an ink jet printing apparatus including: a table which places a print medium on; a medium setting unit which sets the print medium on the table situated at an initial position; a switching unit which switches the print medium to a fixed state or a released state with respect to the table; a carrying unit which carries the table; at least one or more print heads which eject ultraviolet curable ink; a first UV curing unit which is provided downstream from each of the print heads along a direction of carrying the table from the initial position toward the print heads and casts ultraviolet rays to provisionally cure the ultraviolet curable ink; and a second UV curing unit which is provided downstream from the first UV curing unit provided on the most downstream side along the direction of carrying the table from the initial position toward the print heads and casts ultraviolet rays to fully cure the ultraviolet curable ink.

### DESCRIPTION OF THE DRAWINGS

FIG. 1 is a front sectional view of an ink jet printing apparatus according to a first embodiment.

FIG. 2 is a side sectional view of the ink jet printing apparatus according to the first embodiment.

FIG. 3 is a side sectional view of a medium setting mechanism according to the first embodiment.

FIG. 4A is a top view of the ink jet printing apparatus according to the first embodiment.

FIG. 4B is a front view of the ink jet printing apparatus according to the first embodiment.

FIG. 5A is a top view of the ink jet printing apparatus according to the first embodiment.

FIG. 5B is a front view of the ink jet printing apparatus according to the first embodiment.

FIG. 6A is a top view of the ink jet printing apparatus according to the first embodiment.

FIG. 6B is a front view of the ink jet printing apparatus according to the first embodiment.

FIG. 7A is a top view of the ink jet printing apparatus according to the first embodiment.

FIG. 7B is a front view of the ink jet printing apparatus according to the first embodiment.

FIG. 8A is a top view of the ink jet printing apparatus according to the first embodiment.

FIG. 8B is a front view of the ink jet printing apparatus according to the first embodiment.

FIG. 9A is a top view of the ink jet printing apparatus according to the first embodiment.

FIG. 9B is a front view of the ink jet printing apparatus according to the first embodiment.

FIG. 10A is a top view of the ink jet printing apparatus according to the first embodiment.

FIG. 10B is a forward front view of the ink jet printing apparatus according to the first embodiment.

FIG. 11 is a graph showing the relation between the speed of a carriage and the integrated light quantity of a provisional curing UV lamp and a full curing UV lamp according to the first embodiment.

FIG. 12 shows an example of carrying speed of the carriage according to the first embodiment.

FIG. 13A shows a print image where the provisional curing UV lamp according to the first embodiment is used.

FIG. 13B shows a print image where the provisional curing UV lamp according to the first embodiment is not used.

FIG. 14A is a top view of the ink jet printing apparatus according to the first embodiment.

FIG. 14B is a front view of the ink jet printing apparatus according to the first embodiment.

FIG. 15A is a top view of the ink jet printing apparatus according to the first embodiment.

FIG. 15B is a front view of the ink jet printing apparatus according to the first embodiment.

FIG. 16 is a flowchart showing the operation of the ink jet printing apparatus according to the first embodiment.

FIG. 17 is a front sectional view showing a modification of the ink jet printing apparatus according to the first embodiment.

FIG. 18 is a front sectional view showing another modification of the ink jet printing apparatus according to the first embodiment.

FIG. 19A is a top view of an ink jet printing apparatus according to a second embodiment.

FIG. 19B is a front view of the ink jet printing apparatus according to the second embodiment.

FIG. 20A is a top view of an ink jet printing apparatus according to a third embodiment.

FIG. 20B is a front view of the ink jet printing apparatus according to the third embodiment.

FIG. 20C is a side view of the ink jet printing apparatus according to the third embodiment.

FIG. 21 is a block diagram showing a control system of the ink jet printing apparatus according to the first embodiment.

FIG. 22 is a schematic view showing a conventional ink jet printing apparatus.

### DETAILED DESCRIPTION

Hereinafter, embodiments will be described with reference to the drawings.

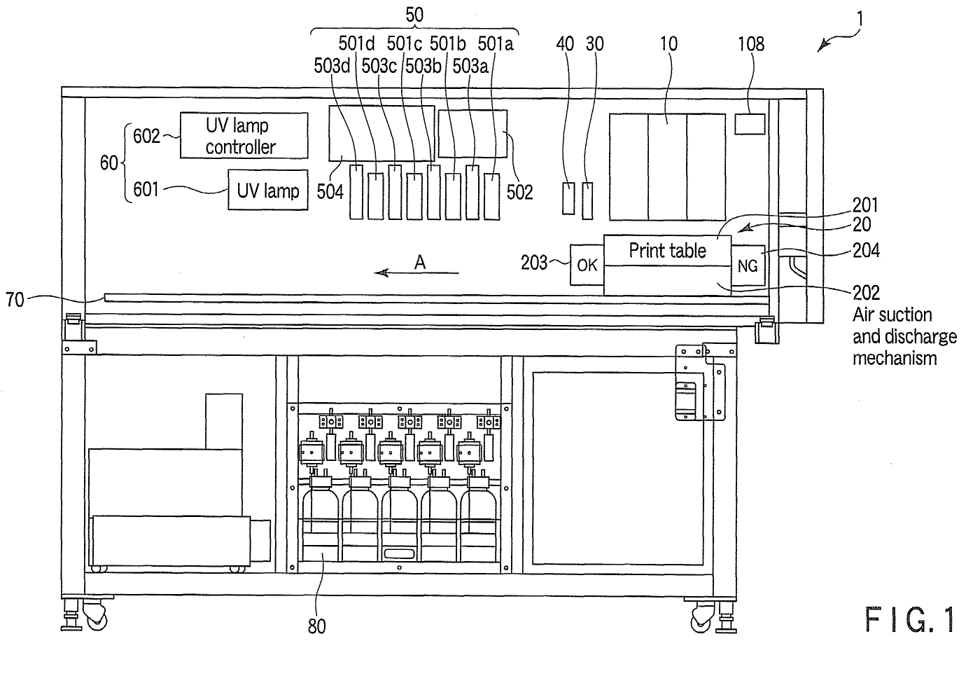

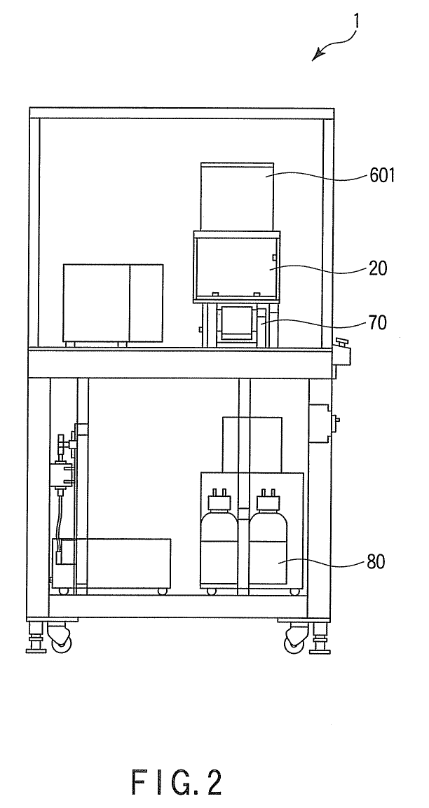

FIG. 1 is a front sectional view of an ink jet printing apparatus 1 according to a first embodiment. FIG. 2 is a side sectional view of the ink jet printing apparatus 1 according to the first embodiment. Here, the ink jet printing apparatus 1 which prints on a print medium p that is not penetrated by ink such as thick paper or card (referred to as a non-penetrable medium p) will be described. FIG. 21 is a block diagram showing a control system of the ink jet printing apparatus 1 according to the first embodiment.

The ink jet printing apparatus 1 mainly includes a medium setting mechanism 10, a carriage 20, a medium collection mechanism 30, a medium setting detection mechanism 40, a printing unit 50, a full curing unit 60, a carrying unit 70, and an ink supply unit 80. The medium setting mechanism 10 sets the non-penetrable medium p on the carriage 20. The configuration of the medium setting mechanism 10 will be described later.

On the carriage 20, the non-penetrable medium p set by the medium setting mechanism 10 is carried by the carrying unit 70. The carrying unit 70 carries the non-penetrable medium p along a carrying direction which is a direction from the medium setting mechanism 10 toward the printing unit 50 (hereinafter defined as direction A). The carrying unit 70 may be a contact-type or non-contact linear slider. Here, the carrying unit 70 having a driving source carries the carriage 20. However, a carriage having a driving source may move on a rail-like carrying unit 70. The carriage 20 has a print table 201, an air suction and discharge mechanism 202, a first medium collection box 203, and a second medium collection box 204. The print table 201 has the non-penetrable medium p placed thereon. The air suction and discharge mechanism 202 sucks or releases the non-penetrable medium p to and from the print table 201.

The first medium collection box 203 is provided before the carriage 20 along direction A. The first medium collection box 203 stores non-penetrable media p on which printing is normally done. The second medium collection box 204 is provided after the carriage 20 along direction A. The second medium collection box 204 stores non-penetrable media p that are not the non-penetrable media p on which printing is normally done.

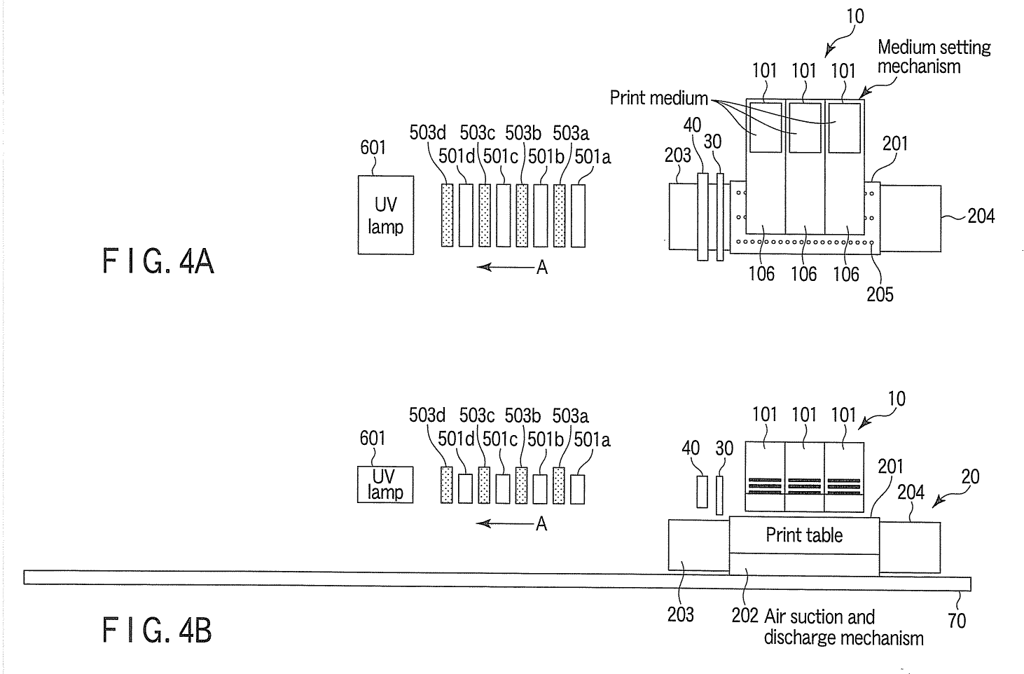

The print table 201 is provided with plural openings 205 (see FIG. 4A). As the air suction and discharge mechanism 202 sucks air, air on the top side of the print table 201 flows into the openings 205. The non-penetrable medium p is now in a fixed state of being sucked to the print table 201. As the air suction and discharge mechanism 202 discharges air, air on the top side of the print table 201 flows out of the openings 205. The non-penetrable medium p is now released from the print table 201.

The medium collection mechanism 30 is provided between the medium setting mechanism 10 and the printing unit 50. The medium collection mechanism 30 collects non-penetrable media p on which an image is normally printed, into the first medium collection box 203. The medium collection mechanism 30 collects non-penetrable media p that are not the non-penetrable media p on which printing is normally done, into the second medium collection box 204. The collection of the non-penetrable media p by the medium collection mechanism 30 will be described later.

The medium setting detection mechanism 40 is provided between the medium setting mechanism 10 and the printing unit 50. In the first embodiment, the medium setting detection mechanism 40 is provided downstream from the medium setting mechanism 10 along direction A. The medium setting detection mechanism 40 determines whether the non-penetrable medium p is normally set at a predetermined position on the print table 201 or not.

The printing unit 50 has print heads 501a, 501b, 501c and 501d, a print port 502, provisional curing UV lamps 503a, 503b, 503c and 503d, and a temperature adjustment unit 504. Each of the print heads 501a, 501b, 501c and 501d is a head that ejects ink of one of four colors C, M, Y and K. The print heads 501a, 501b, 501c and 501d are arrayed along direction A. Here, for example, the print head 501a ejects K ink, the print head 501b ejects Y ink, the print head 501c ejects M ink, and the print head 501d ejects C ink. The print port 502 controls the quantity of ink ejected from the print heads 501a, 501b, 501c and 501d and timing of ejection in accordance with image data transmitted from a PC 902 as an external device. In this embodiment, ultraviolet curable ink is used which cures when irradiated with ultraviolet rays.

The provisional curing UV lamp 503a is provided between the print head 501a and the print head 501b along direction A. Similarly, the provisional curing UV lamp 503b is provided between the print head 501b and the print head 501c. The provisional curing UV lamp 503c is provided between the print head 501c and the print head 501d. The provisional curing UV lamp 503d is provided immediately downstream from the print head 501d.

The provisional curing UV lamp 503a casts ultraviolet rays immediately after printing is done on the non-penetrable medium p by the print head 501a. The provisional curing UV lamps 503b to 503d operate similarly. The ink on the surface of the non-penetrable medium p begins to be cured by the provisional curing UV lamps 503a to 503d. The ink on the surface of the non-penetrable medium p is in a provisional curing state where the ink is not fully cured because of the small quantity of light from the provisional curing lamps 503a to 503d. The temperature adjustment unit 504 adjusts the temperature of the print heads 501a to 501d. For example, the temperature adjustment unit 504 circulates water of an arbitrary temperature to the print heads 501a to 501d and thereby adjusts the print heads to a desired temperature.

The full curing unit 60 has a full curing UV lamp 601 and a UV lamp controller 602. The full curing UV lamp 601 casts a greater quantity of light to the non-penetrable medium p than the provisional curing UV lamps 503a to 503d. The full curing UV lamp 601 fully cures the ink on the surface of the non-penetrable medium p after printing is done by all the print heads 501a to 501d. The ink on the surface of the non-penetrable medium p is now fixed to the non-penetrable medium p. The UV lamp controller 602 adjusts the quantity of light to be cast and its timing.

The ink supply unit 80 is provided below the printing unit 50. The ink supply unit 80 supplies ink to the print heads 501a to 501d.

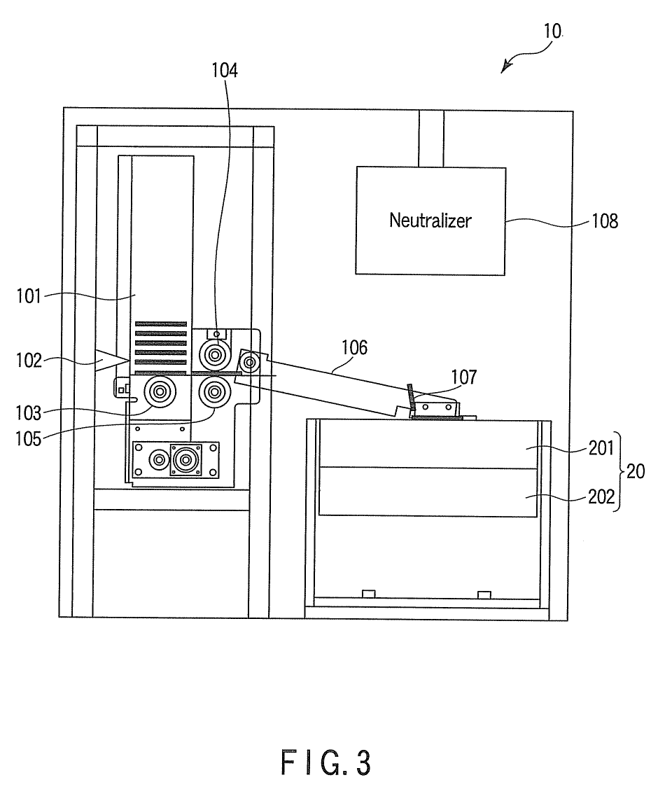

Next, the configuration of the medium setting mechanism 10 will be described. FIG. 3 is a side sectional view of the medium setting mechanism 10. FIG. 4A is a schematic view of the ink jet printing apparatus 1 as viewed from above. FIG. 4B is a schematic view of the ink jet printing apparatus 1 as viewed from the front. FIG. 4A and FIG. 4B show the state before the medium setting mechanism 10 sets the non-penetrable medium p on the print table 201.

The medium setting mechanism 10 has a card setting table 101, a card sensor 102, a card setting roller 103, a first card discharge roller 104, a second card discharge roller 105, a card discharge table 106, a card feeding speed adjusting unit 107, and a neutralizer 108. The card setting table 101 has a non-penetrable medium p loaded thereon in the direction of height. The card sensor 102 detects whether a non-penetrable medium p is loaded on the card setting table 101 or not.

The card setting roller 103 carries a non-penetrable medium p situated in the bottom stage of the card setting table 101 to the first card discharge roller 104 and the second card discharge roller 105. The first card discharge roller 104 and the second card discharge roller 105 are provided facing each other in the direction of height. The card discharge table 106 is a path provided with a downward inclination from the first card discharge roller 104 and the second card discharge roller 105 toward the top side of the print table 201. The card feeding speed adjusting unit 107 is provided at the position on the card discharge table 106 facing the print table 201. The card feeding speed adjusting unit 107 is provided to cover the inside of the card discharge table 106. When contacted by the non-penetrable medium p, the card feeding speed adjusting unit 107 moves along the direction of discharging the non-penetrable medium p.

After a control unit 901 receives a print start signal from a PC 902 via an interface 903, the card setting roller 103 carries the non-penetrable medium p to the first card discharge roller 104 and the second card discharge roller 105. As the first card discharge roller 104 and the second card discharge roller 105 eject the non-penetrable medium p, the non-penetrable medium p passes through the card discharge table 106. The non-penetrable medium p decelerates by colliding with the card feeding speed adjusting unit 107 within the card discharge table 106 and thus moves onto the print table 201.

When the first card discharge roller 104 and the second card discharge roller 105 discharge the non-penetrable medium p, the air suction and discharge mechanism 202 sucks air via the openings 205 provided in the print table 201. At least before the non-penetrable medium p reaches the top of the print table 201, the air suction and discharge mechanism 202 starts sucking air via the openings 205 provided in the print table 201. Therefore, the non-penetrable medium p discharged by the first card discharge roller 104 and the second card discharge roller 105 is set at a predetermined position on the print table 201 by the card feeding speed adjusting unit 107 and the suction by the air suction and discharge mechanism 202. In order to facilitate setting of the non-penetrable medium p at the predetermined position on the print table 201, a shallow groove which the non-penetrable medium p can fit may be provided at the predetermined position on the print table 201. The predetermined position is, for example, a position where the sides of the rectangular non-penetrable medium p are parallel and orthogonal to direction A and the non-penetrable medium p faces the print heads 501a to 501d when the carriage 20 having the non-penetrable medium p placed thereon is moved in direction A.

The neutralizer 108 blasts and adheres a liquid or gas having an antistatic effect (hereinafter referred to as an antistatic agent) to the print surface of the non-penetrable medium p. The neutralizer 108 blasts the antistatic agent when or before and after the non-penetrable medium p is set at the predetermined position on the print table 201. The neutralizer 108 may also be configured to apply the antistatic agent to the print surface of the non-penetrable medium p by using a brush. The neutralizer 108 may also blast the antistatic agent before the non-penetrable medium p is set at the predetermined position on the print table 201 and before the first card discharge roller 104 and the second card discharge roller 105 eject the non-penetrable medium p.

As the neutralizer 108 blasts the antistatic agent to the non-penetrable medium p, the surface of the non-penetrable medium p is neutralized before printing is carried out by the printing unit 50. Therefore, the neutralizer 108 can prevent beforehand deterioration in image quality on the non-penetrable medium p on which printing is carried out by the printing unit 50.

As shown in FIG. 4A and FIG. 4B, three sheets of non-penetrable media p at a maximum are put on the print table 201 along direction A. Therefore, the medium setting mechanism 10 has three sets each including the card setting table 101, the card sensor 102, the card setting roller 103, the first card discharge roller 104, the second card discharge roller 105, the card discharge table 106 and the card feeding speed adjusting unit 107.

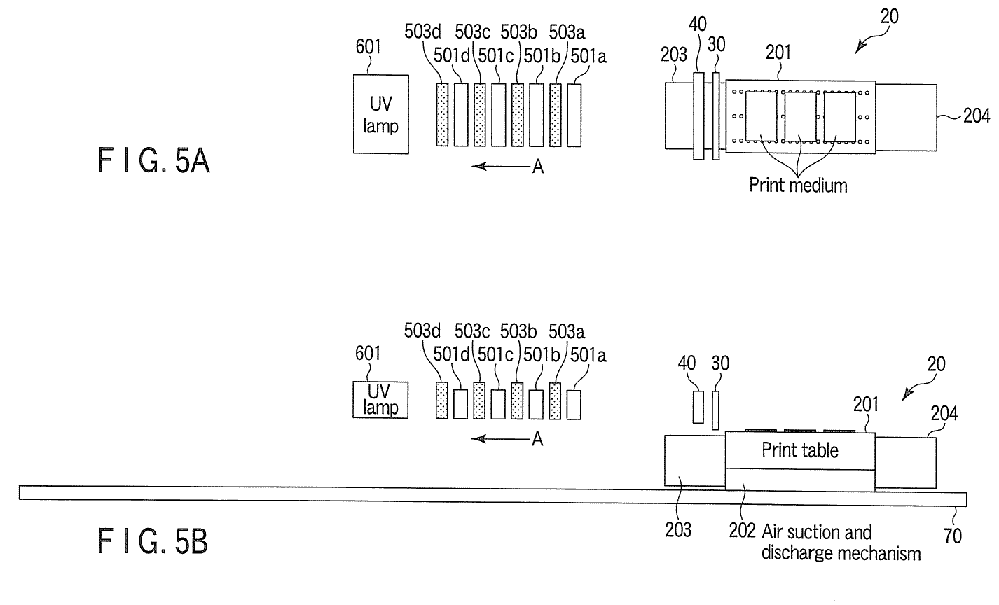

Next, printing on a non-penetrable medium p and collection of non-penetrable media p will be described. FIG. 5A is a schematic view showing the ink jet printing apparatus 1 as viewed from above, in a state changed from the state shown in FIG. 4A. FIG. 5B is a schematic view showing the ink jet printing apparatus 1 as viewed from the front, in a state changed from the state shown in FIG. 4B.

As shown in FIG. 5A and FIG. 5B, it is a normal state when three sheets of non-penetrable media p ejected by the first card discharge roller 104 and the second card discharge roller 105 are placed on the print table 201 orthogonally to the carrying direction. Here, the position taken by the carriage 20 when the medium setting mechanism 10 places the non-penetrable media p on the print table 201 is assumed to be an initial position. As three sheets of non-penetrable media p are placed on the print table 201, the carriage 20 moves along direction A from the initial position. The control unit 901 drives the carrying unit 70 to move the carriage 20 after a counter 904 counts a predetermined time, irrespective of whether the non-penetrable media p are normally placed on the print table 201 or not. The predetermined time is, for example, a time counted after the first card discharge roller 104 and the second card discharge roller 105 eject the non-penetrable media p.

If three sheets of non-penetrable media p are placed at the predetermined position on the print table 201, the suction force to the three sheets of non-penetrable media p on the print table 201 is increased. However, if even one sheet is shifted from the predetermined position, the suction force to the non-penetrable media p is decreased.

The medium setting detection mechanism 40 detects whether a non-penetrable medium p is placed at the predetermined position on the print table 201 or not after the first card discharge roller 104 and the second card discharge roller 105 eject the non-penetrable medium p. The medium setting detection mechanism 40 may be a non-contact electromagnetic, optical or other sensor, or may be a contact-type sensor provided on the print table 201.

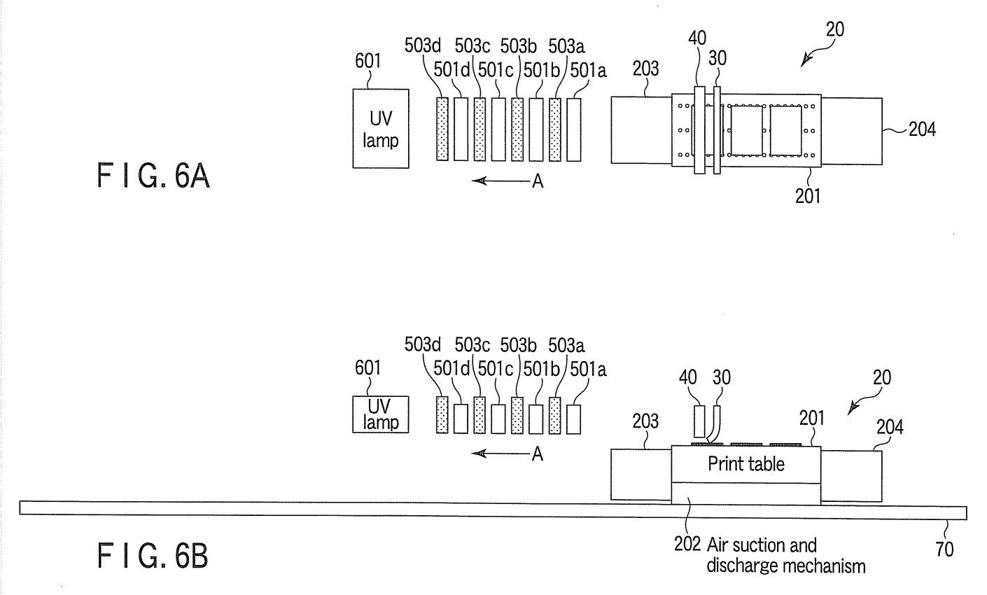

FIG. 6A is a schematic view showing the ink jet printing apparatus 1 as viewed from above, in a state changed from the state shown in FIG. 5A. FIG. 6B is a schematic view showing the ink jet printing apparatus 1 as viewed from the front, in a state changed from the state shown in FIG. 5B.

The medium collection mechanism 30 has a shape extending in the direction of height and uses an elastic member. The distal end part of the medium collection mechanism 30 is provided at a position where it flexes by contacting the non-penetrable medium p placed on the print table 201 if the carriage 20 moves along direction A from the initial position to the position where the printing unit 50 is provided. Then the medium collection mechanism 30 slides in contact with the non-penetrable medium p. The position and material of the distal end part of the medium collection mechanism 30 is designed within such a range that the non-penetrable medium p does not shift from the position where it is placed when the medium collection mechanism 30 slides in contact with the non-penetrable medium p placed in a state of being sucked to the print table 201 by the air suction and discharge mechanism 202.

If the medium setting detection mechanism 40 detects that the position of the non-penetrable medium p placed on the print table 201 is shifted from the predetermined position, the medium setting detection mechanism 40 outputs an NG signal to the control unit 901. The control unit 901 causes the suction and discharge mechanism 202 to stop suction. As the air suction and discharge mechanism 202 stops suction, the non-penetrable medium p is released from the print table 201. The medium collection mechanism 30 regulates the non-penetrable medium p so that the non-penetrable medium p does not follow the movement of the carriage 20 along direction A. As the carriage 20 passes the position where the medium collection mechanism 30 is provided, the non-penetrable medium p placed on the print table 201 is swept off into the second medium collection box 204 by the medium collection mechanism 30. The control unit 901 transmits, to the print port 502, a signal to suspend the printing by the operating print heads 501a to 501d with respect to the carriage 20 in this state.

Even if the medium setting detection mechanism 40 detects that the position of the non-penetrable medium p placed on the print table 201 is not shifted from the predetermined position, if the suction of the non-penetrable medium p by the air suction and discharge mechanism 202 is weak, the non-penetrable medium p may shift from the predetermined position while the carriage 20 is moving, and accurate print may not be made. Thus, the medium collection mechanism 30 regulates the non-penetrable medium p so that the non-penetrable medium p does not follow the movement of the carriage 20. As the carriage 20 passes the position where the medium collection mechanism 30 is provided, the non-penetrable medium p placed on the print table 201 is swept off into the second medium collection box 204 by the medium collection mechanism 30. Meanwhile, if the medium setting detection mechanism 40 detects that the position of the non-penetrable medium p placed on the print table 201 is shifted from the predetermined position by the medium collection mechanism 30, the medium setting detection mechanism 40 outputs an NG signal to the control unit 901.

Now, as the control unit 901 receives the NG signal, the control unit 901 outputs a print stop signal so that the printing unit 50 does not execute printing. The carriage 20 returns to the initial position after passing the position where the medium collection mechanism 30 is provided.

The medium collection mechanism 30 may be vertically movable. That is, the control unit 901 may drive a driving motor 905 to cause the medium collection mechanism 30 to retreat upward until the carriage 20 moves to the position where the printing unit 50 is provided.

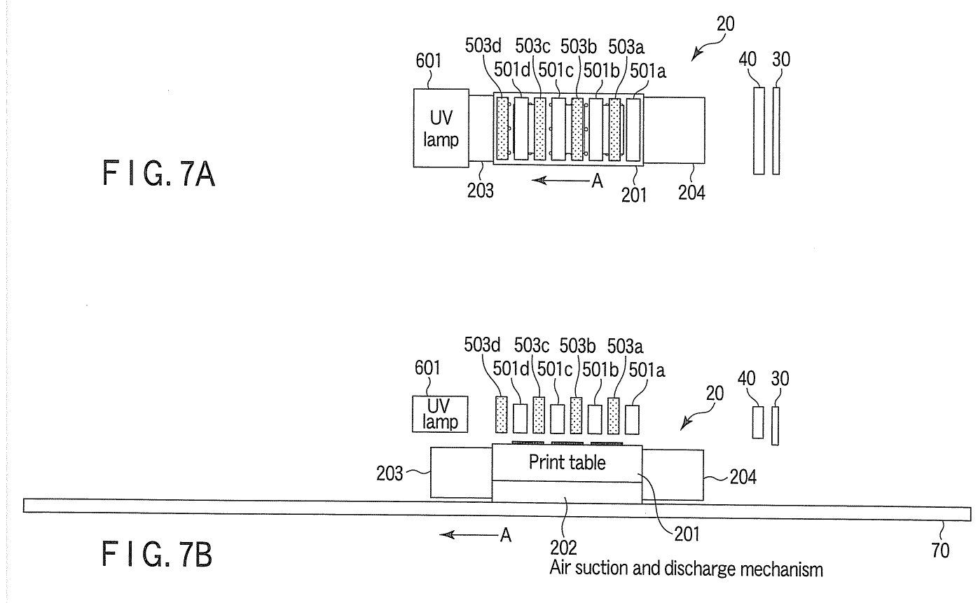

FIG. 7A is a schematic view showing the ink jet printing apparatus 1 as viewed from above, in a state changed from the state shown in FIG. 6A. FIG. 7B is a schematic view showing the ink jet printing apparatus 1 as viewed from the front, in a state changed from the state shown in FIG. 6B.

The print heads 501a to 501d sequentially print on the three sheets of non-penetrable media p on the print table 201 as the carriage 20 moves. The provisional curing UV lamps 503a to 503d start casting ultraviolet rays immediately after the print heads 501a to 501d print on the non-penetrable media p. A part of the non-penetrable medium p where printing with K ink is carried out by the print head 501a is irradiated with an integrated light quantity of the provisional curing UV lamps 503a to 503d. The provisional curing UV lamps 503a to 503d provisionally cure the ink on the non-penetrable medium p.

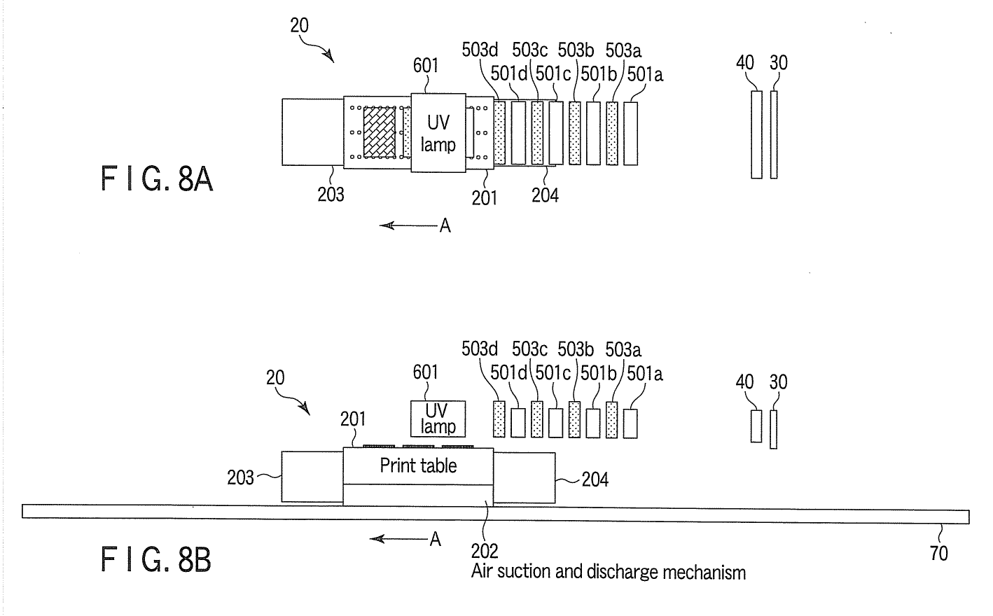

FIG. 8A is a schematic view showing the ink jet printing apparatus 1 as viewed from above, in a state changed from the state shown in FIG. 7A. FIG. 8B is a schematic view showing the ink jet printing apparatus 1 as viewed from the front, in a state changed from the state shown in FIG. 7B.

After passing the position where the printing unit 50 is provided, the carriage 20 moves to the position where the full curing unit 60 is provided. The full curing UV lamp 601 casts ultraviolet rays to the non-penetrable medium p on which printing is carried out by each of the print heads 501a to 501d. The full curing UV lamp 601 fully cures the ink on the non-penetrable medium p. The speed at which the carriage 20 passes the position where the full curing unit 60 is provided may be slower than the speed at which the carriage 20 passes the printing unit 50. As the speed of the carriage 20 is slowed down, the integrated quantity of light cast onto the non-penetrable medium p by the full curing UV lamp 601 can be increased.

In the first embodiment, the print head 501a ejecting K ink, the print head 501b ejecting Y ink, the print head 501c ejecting M ink and the print head 501d ejecting C ink are provided in order of distance from the full curing UV lamp 601, with the print head 501a being the farthest. As described above, the ink ejected onto the non-penetrable medium p by the print head 501a provided far from the full curing UV lamp 601 is irradiated with the integrated quantity of light of the provisional curing UV lamps 503a to 503d and therefore irradiated with the largest quantity of light. Thus, if the order of difficulty in curing is K ink, Y ink, M ink and C ink, with K ink being the hardest to cure, the first embodiment enables optimum curing of the ink on the non-penetrable medium p.

Alternatively, the print heads 501a to 501d may be provided in order of ink chroma such that the print head ejecting the ink having the lowest chroma of K ink, Y ink, M ink and C ink is provided at the closest position to the full curing UV lamp 601. Specifically, each of the print heads 501a to 501c ejects one of Y ink, M ink and C ink, and the print head 501d ejects K ink. K ink is often used in a large amount when printing on the non-penetrable medium p. Here, a case of using a large amount of K ink will be described, but this is not the only case. If it takes long until the full curing UV lamp 601 casts ultraviolet rays to K ink on the non-penetrable medium p after printing with K ink is carried out on the non-penetrable medium p, the print image spreads. The light from the provisional curing UV lamps 503a to 503d provided downstream from the print heads 501a to 501d along direction A is smaller in quantity than the light from the full curing UV lamp 601 and shorter in irradiation time. If print heads 501a to 501d print on the non-penetrable medium p with the ink of each color overlapping or being next to each other, the provisional curing UV lamps 503a to 503d cannot fully cure the ink on the non-penetrable medium p. The ink spreads particularly at the edge of a character part of the print image. If the print head 501d ejects K ink, the print image after the ink on the non-penetrable medium p is cured by the full curing UV lamp 601 becomes sharper.

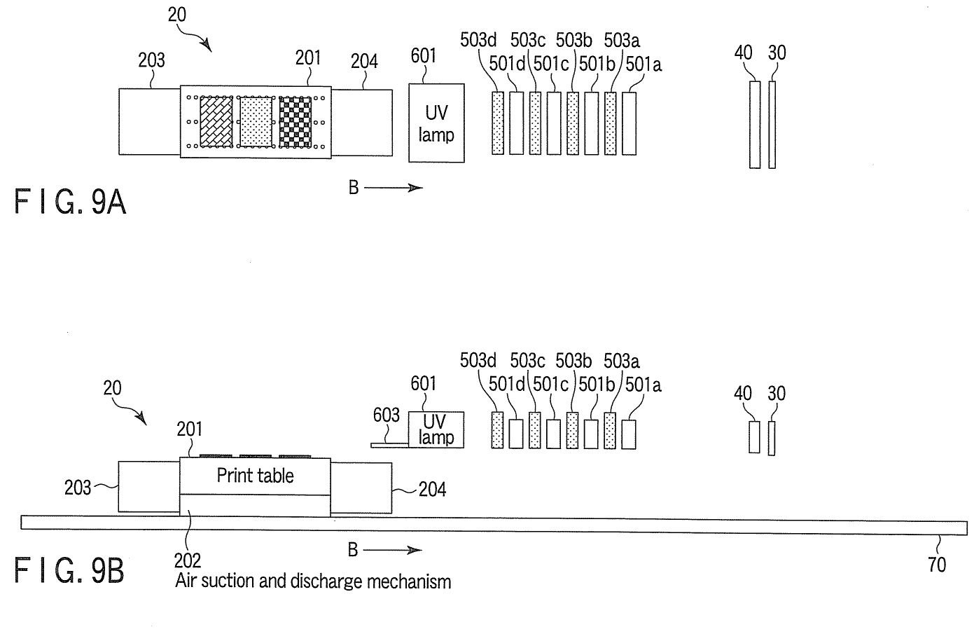

FIG. 9A is a schematic view showing the ink jet printing apparatus 1 as viewed from above, in a state changed from the state shown in FIG. 8A. FIG. 9B is a schematic view showing the ink jet printing apparatus 1 as viewed from the front, in a state changed from the state shown in FIG. 8B.

After completely passing the position where the full curing unit 60 is provided, the carriage 20 starts moving in a direction from the full curing unit 60 toward the medium setting mechanism 10 (hereinafter referred to as direction B). The speed of the carriage 20 may be faster than the speed at which the carriage 20 passes the printing unit 50 in direction A and the speed at which the carriage 20 passes the full curing unit 60 in direction A, in order to improve work efficiency and productivity. Also, in order to increase the integrated quantity of light cast to the non-penetrable medium p by the full curing UV lamp 601 and to fully cure the ink printed on the non-penetrable medium p, the speed of the carriage 20 passing the full curing unit 60 in direction B may be the same as the speed at which the carriage 20 passes the full curing unit 60 in direction A. The moving speed may also be raised after the carriage 20 passes the full curing unit 60 in direction B.

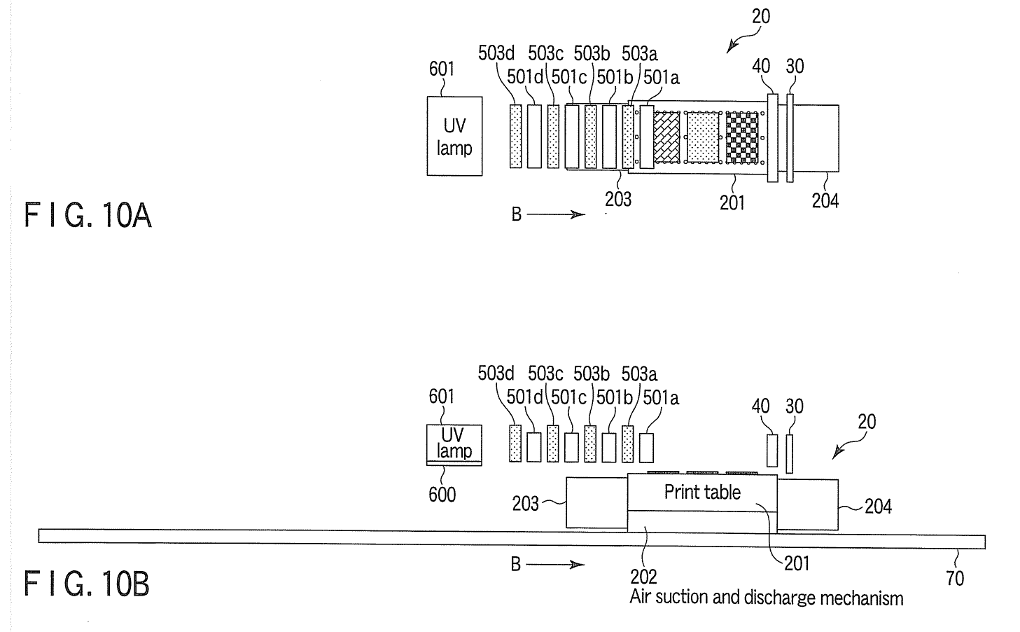

FIG. 10A is a schematic view showing the ink jet printing apparatus 1 as viewed from above, in a state changed from the state shown in FIG. 9A. FIG. 10B is a schematic view showing the ink jet printing apparatus 1 as viewed from the front, in a state changed from the state shown in FIG. 9B.

As the carriages 20 passes the position where the full curing unit 60 is provided, along direction B, the UV lamp controller 602 controls to shut off ultraviolet rays by covering the irradiation surface of the UV lamp 601 with a shutter 603 or the like.

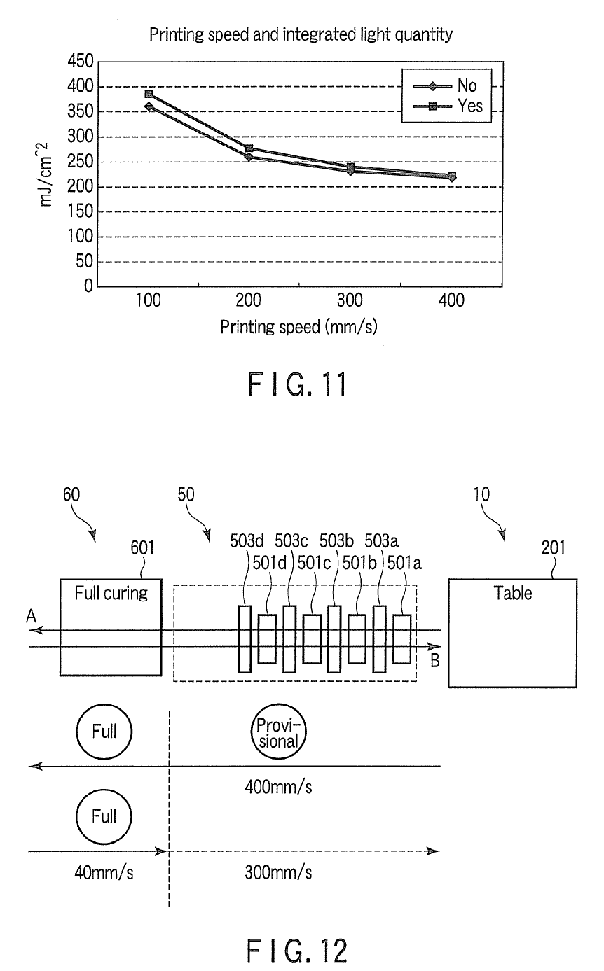

FIG. 11 is a graph showing the measured relation between the speed of the carriage 20 and the integrated light quantity of the provisional curing UV lamps 503a to 503d and the full curing UV lamp 601. Here, the horizontal axis represents the speed at which the carriage 20 moves along direction A. The vertical axis represents the sum of the quantity of light cast by the provisional curing UV lamps 503a to 503d and the full curing UV lamp 601 when the carriage 20 moves in direction A and the quantity of light cast by the full curing UV lamp 601 when the carriage 20 moves in direction B. As the provisional curing UV lamps 503a to 503d are provided in the ink jet printing apparatus 1, the integrated quantity of light cast to the non-penetrable medium p is increased. The result of the experiment shows that even if the carriage 20 moves at 400 mm/s in direction A, the effect of the adhesiveness of the ink to the non-penetrable medium p is achieved. In order to further improve the adhesiveness of the ink to the non-penetrable medium p, the carriage 20 may be moved at 40 mm/s until the carriage 20 passes the position where the full curing unit 60 is provided, in direction B.

FIG. 12 shows a specific example of the carrying speed of the carriage 20 based on the measurement result. The carriage 20 passes the position where the printing unit 50 is provided, along direction A, and moves at 400 mm/s until it passes the position where the full curing unit 60 is provided. After that, the carriage 20 moves at 40 mm/s along direction B until it passes the position where the full curing unit 60 is provided. When passing the position where the full curing unit 60 is provided, along direction B, the carriage 20 moves at a speed slower than when passing the position where the full curing unit 60 is provided, along direction A. After that, the carriage 20 moves at 300 mm/s until it passes the position where the printing unit 50 is provided, along direction B. While the carriage 20 passes the position where the curing unit 60 is provided, along direction B, the provisional curing UV lamps 503a to 503d stop casting ultraviolet rays to the non-penetrable medium p. The ink on the non-penetrable medium p is fully cured by the above process.

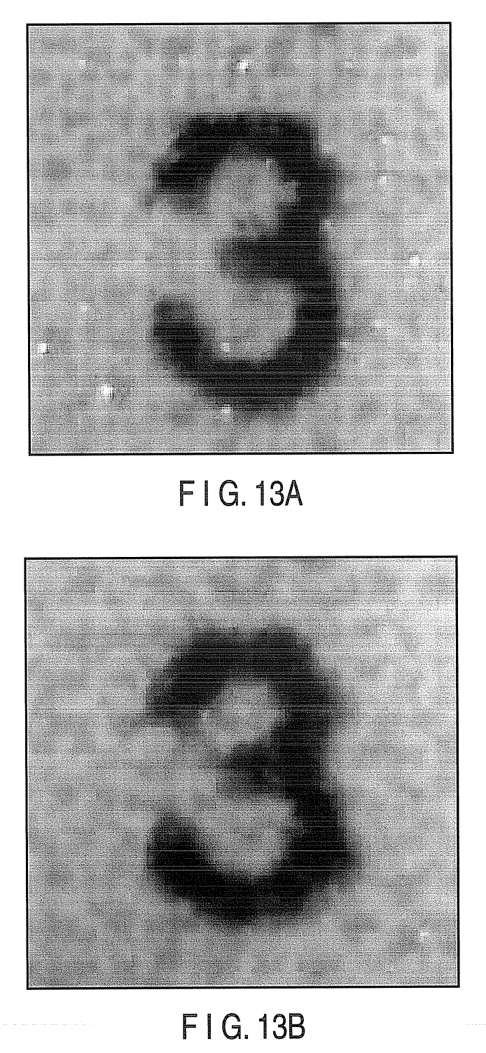

FIG. 13A shows a print image in the case where the ink on the non-penetrable medium p is cured by the above process using the provisional curing UV lamps 503a to 503d and the full curing UV lamp 601. FIG. 13B shows a print image in the case where the ink on the non-penetrable medium p is cured by the above process using the full curing UV lamp 601 alone. As shown in FIG. 13A, as the provisional curing UV lamps 503a to 503d are provided in the ink jet printing apparatus 1, the edge of the character of the print image becomes sharper.

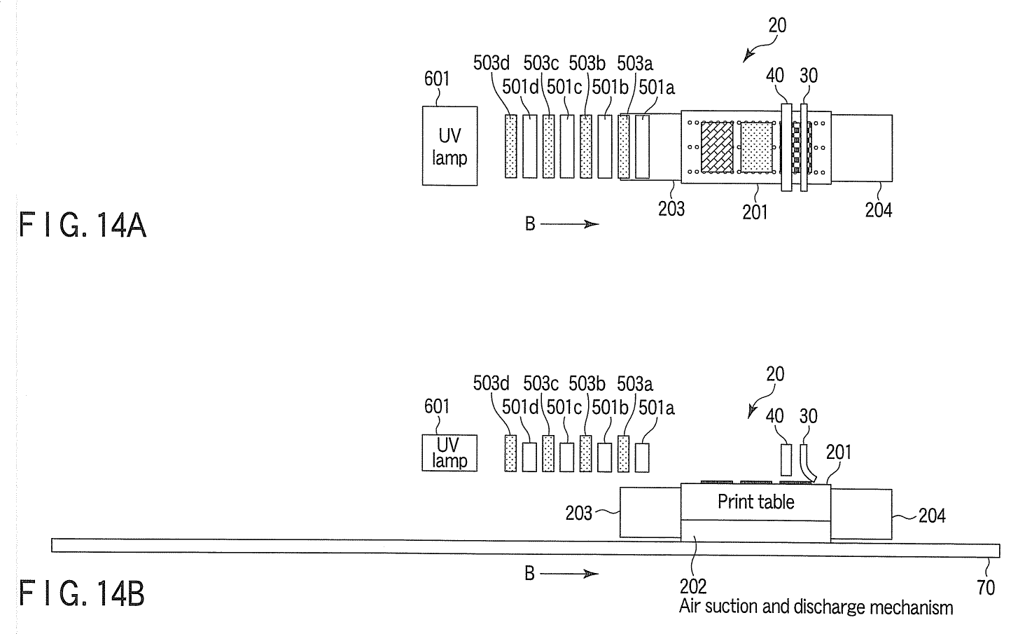

FIG. 14A is a schematic view showing the ink jet printing apparatus 1 as viewed from above, in a state changed from the state shown in FIG. 10A. FIG. 14B is a schematic view showing the ink jet printing apparatus 1 as viewed from the front, in a state changed from the state shown in FIG. 10B.

As the carriage 20 reaches the position where the medium setting detection mechanism 40 is provided (which may be a position upstream from the medium collection mechanism 30 along direction B) in direction B, the control unit 901 causes the air suction and discharge mechanism 202 to stop suction. As the air suction and discharge mechanism 202 stops suction, the non-penetrable medium p is released from the print table 201. After that, when the carriage 20 moves along direction B, the medium collection mechanism 30 regulates the non-penetrable medium p so that the non-penetrable medium p does not follow the movement of the carriage 20.

As the carriage 20 passes the position where the medium collection mechanism 30 is provided, the medium collection mechanism 30 sweeps off the non-penetrable medium p placed on the print table 201 into the first medium collection box 203.

The medium collection mechanism 30 is vertically movable. If the medium collection mechanism 30 is retreating upward, the control unit 901 drives the driving motor 905 to move the medium collection mechanism 30 to the position where the distal end part of the medium collection mechanism 30 slides in contact with the non-penetrable medium p before the carriage 20 approaches the position where the medium collection mechanism 30 is provided.

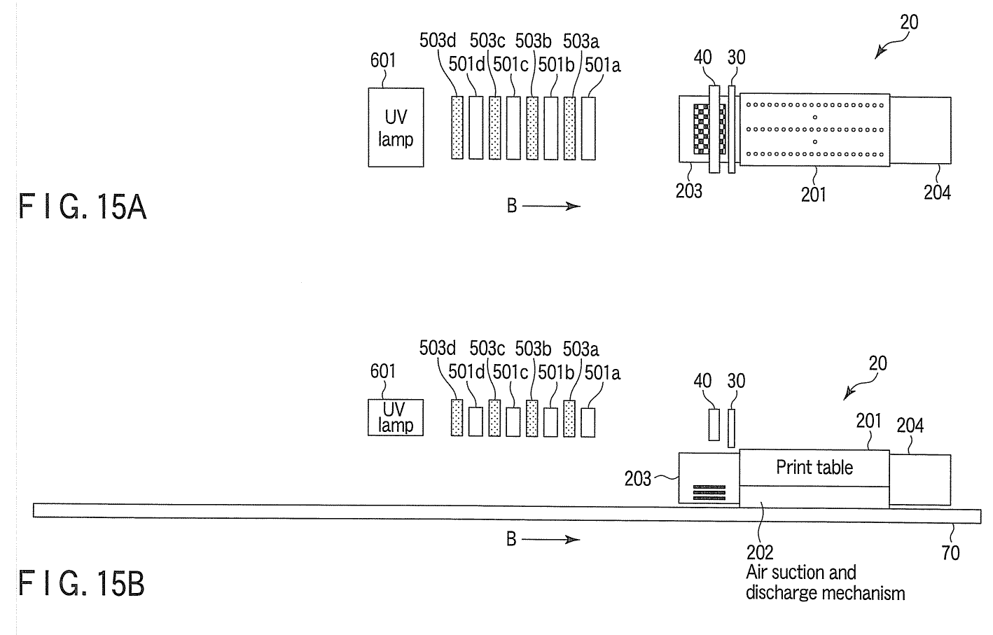

FIG. 15A is a schematic view showing the ink jet printing apparatus 1 as viewed from above, in a state changed from the state shown in FIG. 14A. FIG. 15B is a schematic view showing the ink jet printing apparatus 1 as viewed from the front, in a state changed from the state shown in FIG. 14B.

As the carriage 20 returns to the initial position where the medium setting mechanism 10 is provided, the medium setting mechanism 10 ejects the next non-penetrable medium p toward the print table 201. When the user takes out the non-penetrable medium p on which printing is carried out normally and which is stored in the first medium collection box 203, the control unit 901 moves the carriage 20 further along direction B to the position where the user can easily take out the non-penetrable medium p, in accordance with a predetermined input.

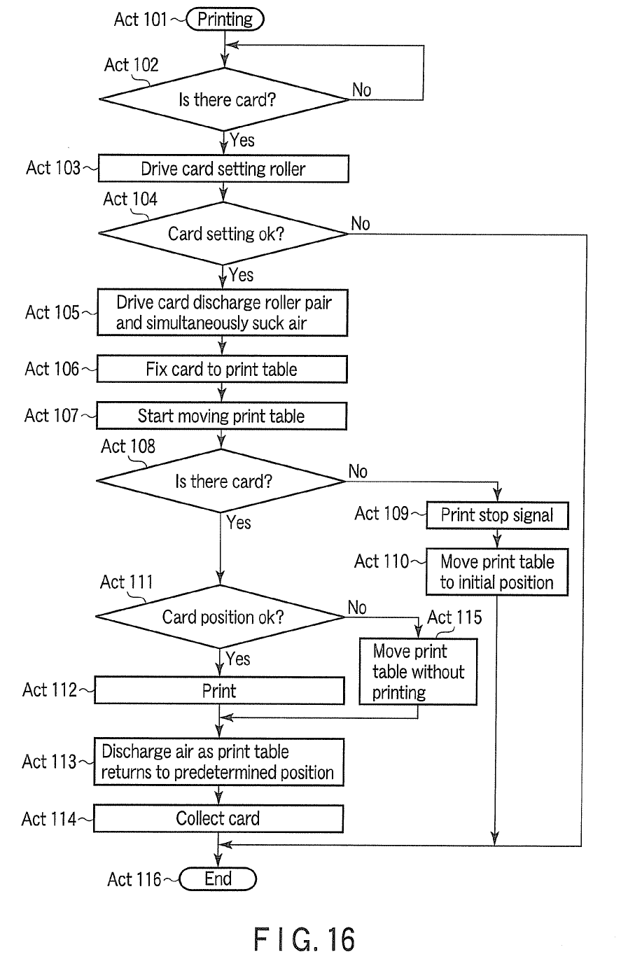

FIG. 16 is a flowchart summarizing the printing on the non-penetrable medium p and the collection of the non-penetrable medium p described above.

First, as the control unit 901 receives a print request from the PC 902, the control unit 901 executes printing (Act 101).

The card sensor 102 determines whether at least one non-penetrable medium p is loaded on the card setting table 101 or not (Act 102).

If at least one non-penetrable medium p is loaded on the card setting table 101 (Yes in Act 102), the card setting roller 103 carries the non-penetrable medium p to the first card discharge roller 104 and the second card discharge roller 105 (Act 103). The control unit 901 determines whether the non-penetrable medium p is normally set on the first card discharge roller 104 and the second card discharge roller 105 (Act 104). If the non-penetrable medium p is not normally set (No in Act 104), the control unit 901 ends printing (Act 115). If the non-penetrable medium p is normally set (Yes in Act 104), the first card discharge roller 104 and the second card discharge roller 105 eject the non-penetrable medium p toward the print table 201. In the same timing, the air suction and discharge mechanism 202 starts suction (Act 105).

The air suction and discharge mechanism 202 sucks and thereby fixes the non-penetrable medium p on the print table 201 (Act 106). After the first card discharge roller 104 and the second card discharge roller 105 eject the non-penetrable medium p, the control unit 901 counts a predetermined time by using the counter 904. After the lapse of the predetermined time, the carriage 20 is driven from the initial position (Act 107).

The medium setting detection mechanism 40 detects whether one or more non-penetrable media p are placed on the print table 201 or not (Act 108). If no non-penetrable medium p is placed (No in Act 108), the control unit 901 transmits a print stop signal to the printing unit 50 (Act 109). After that, the carriage 20 moves to the initial position (Act 110). The control unit 901 then ends printing (Act 116).

If one or more non-penetrable media p are placed (Yes in Act 108), the medium setting detection mechanism 40 determines whether the non-penetrable medium p is normally set at a predetermined position on the print table 201 or not (Act 111).

If the non-penetrable medium p is normally set on the print table 201 (Yes in Act 111), the printing unit 50 prints on the non-penetrable medium p on the print table 201 (Act 112).

After printing is carried out on the non-penetrable medium p, the carriage 20 moves until it passes the position where the full curing UV lamp 601 is provided. After that, the carriage 20 moves along direction B. Then, as the carriage 20 reaches the position where the medium setting detection mechanism 40 is provided (which may be a position upstream from the medium collection mechanism 30 along direction B), the air suction and discharge mechanism 202 stops suction (Act 113).

As the carriage 20 moves further in direction B, the medium collection mechanism 30 sweeps off the non-penetrable medium p placed on the print table 201 into the first medium collection box 203 (Act 114). Then, as the carriage 20 returns to the initial position, the control unit 901 ends printing (Act 115).

If the non-penetrable medium p is not normally set on the print table 201 (No in Act 111), the control unit 901 transmits a print stop signal to the printing unit 50 and the carriage 20 moves along direction A from the initial position (Act 115).

Then, the air suction and discharge mechanism 202 stops suction at the position upstream from the medium collection mechanism 30 along direction A (Act 113). As the carriage 20 moves further in direction A, the medium collection mechanism 30 sweeps off the non-penetrable medium p placed on the print table 201 into the second medium collection box 204 (Act 114). Then, as the carriage 20 returns to the initial position along direction B, the control unit 901 ends printing (Act 115).

As described above, with the ink jet printing apparatus 1 according to the first embodiment, a non-penetrable medium p on which printing is normally carried out and the other non-penetrable media p can be efficiently and separately collected.

As described above, the neutralizer 108 is provided in the medium setting mechanism 10. However, a modification of the configuration will now be described.

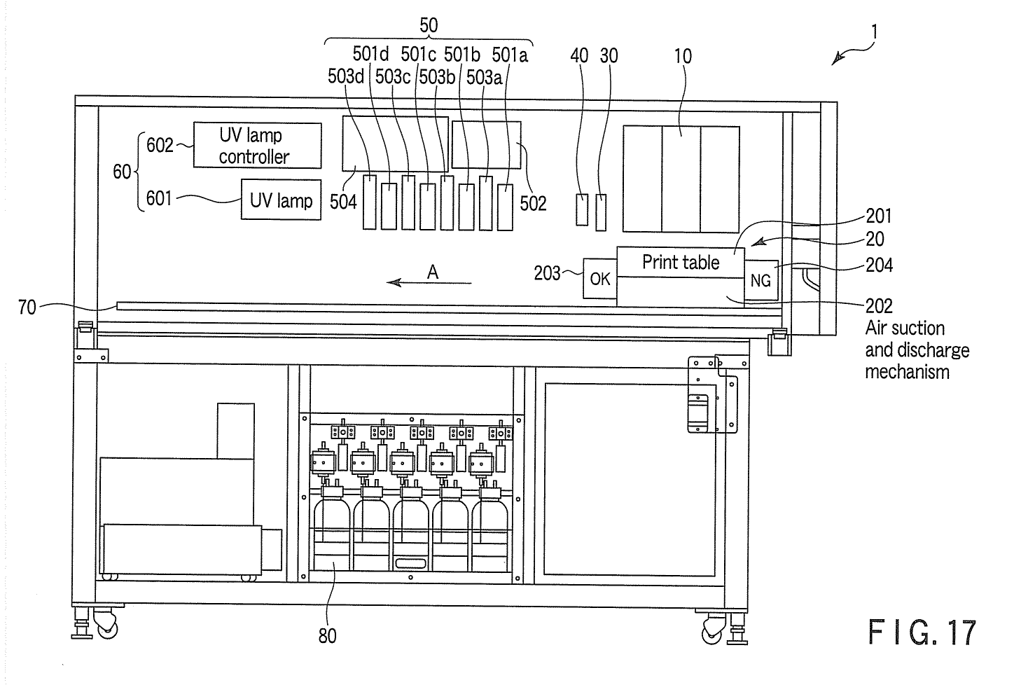

FIG. 17 is a front sectional view showing the ink jet printing apparatus 1 having the configuration of FIG. 1 excluding the neutralizer 108. Here, the medium collection mechanism 30 is made of a material having an antistatic effect. When the carriage 20 having a non-penetrable medium p placed thereon moves along direction A from the initial position, the distal end part of the medium collection mechanism 30 slides in contact with the non-penetrable medium p placed on the print table 201. The medium collection mechanism 30 can neutralize the non-penetrable medium p before printing is carried out by the printing unit 50. Therefore, the medium collection mechanism 30 can prevent beforehand deterioration in image quality on the non-penetrable medium p on which printing is carried out by the printing unit 50.

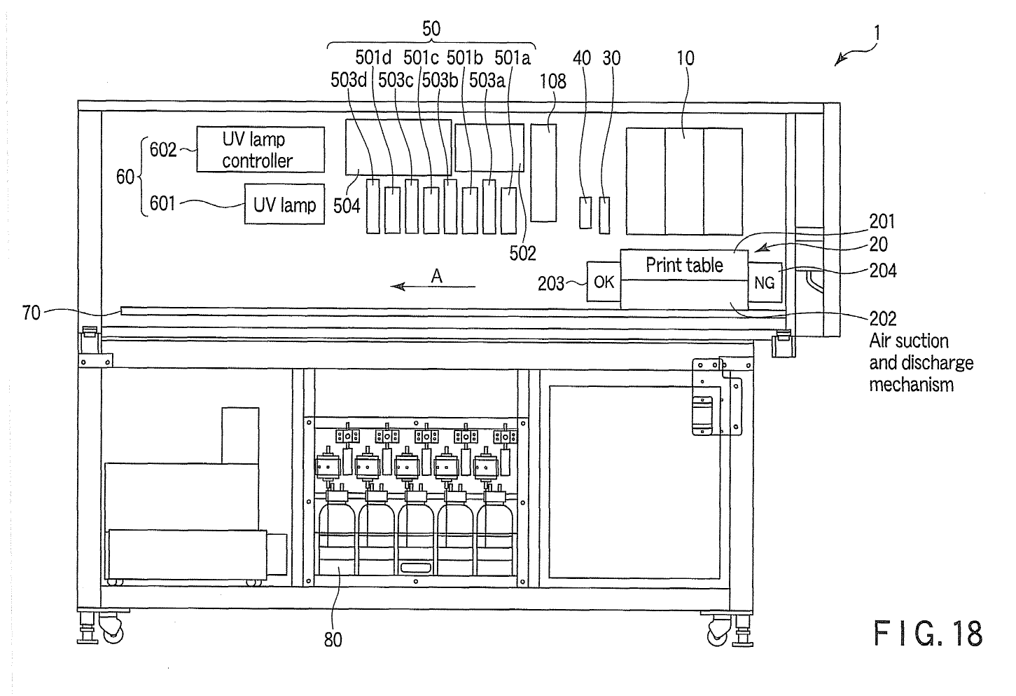

FIG. 18 is a front sectional view showing the ink jet printing apparatus 1 in which the neutralizer 108 shown in FIG. 1 is provided between the medium setting detection mechanism 40 and the printing unit 50.

When the carriage 20 having a non-penetrable medium p placed thereon moves along direction A from the initial position, the neutralizer 108 adheres an antistatic agent to the non-penetrable medium p and thus neutralizes the surface of the non-penetrable medium p before printing is carried out by the printing unit 50. Therefore, the neutralizer 108 can prevent beforehand deterioration in image quality on the non-penetrable medium p on which printing is carried out by the printing unit 50.

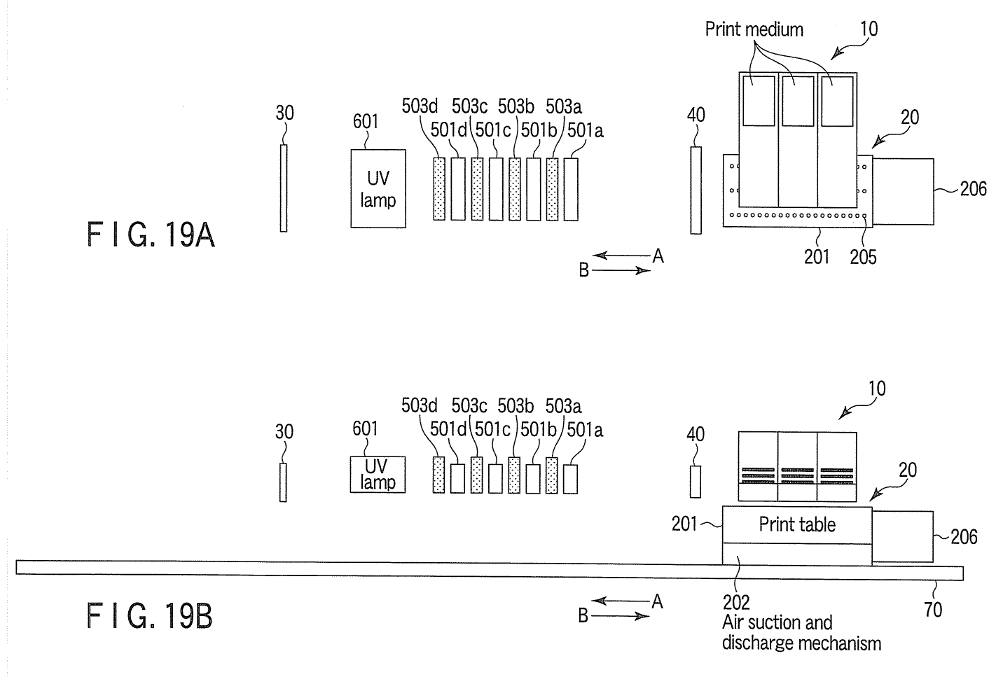

FIG. 19A is a schematic view showing an ink jet printing apparatus 1 according to a second embodiment as viewed from above. FIG. 19B is a schematic view showing the ink jet printing apparatus 1 according to the second embodiment as viewed from the front. In the second embodiment, the medium collection mechanism 30 is provided downstream from the full curing UV lamp 601 along direction A. On the forward side from the carriage 20 in direction A, the first medium collection box 203 is not provided, unlike the first embodiment shown in FIG. 1. A medium collection box 206 is provided on the rear side from the carriage 20 in direction A. The medium collection box 206 stores all the non-penetrable media p placed on the print table 201, irrespective of whether printing is normally carried out or not.

The printing by the printing unit 50 to the non-penetrable medium p placed on the carriage 20 and the irradiation by the full curing UV lamp 601 are the same as in the first embodiment. In the second embodiment, the carriage 20 passes the position where the full curing UV lamp 601 is provided, along direction A, and then moves further toward the position where the medium collection mechanism 30 is provided. At this point, the non-penetrable medium p set on the print table 201 by the medium setting mechanism is placed on the print table 201 irrespective of whether printing is normally carried out by the printing unit 50 or not.

As the carriage 20 reaches an upstream side from the position where the medium collection mechanism 30 is provided, along direction A, the air suction and discharge mechanism 202 stops suction. As the air suction and discharge mechanism 202 stops suction, the non-penetrable medium p is released from the print table 201. After that, when the carriage 20 moves to pass the position where the medium collection mechanism 30 is provided, along direction A, the medium collection mechanism 30 regulates the non-penetrable medium p so that the non-penetrable medium p does not follow the movement of the carriage 20.

As the carriage 20 passes the position where the medium collection mechanism 30 is provided, the medium collection mechanism 30 sweeps off the non-penetrable medium p placed on the print table 201 into the medium collection box 206.

In the second embodiment, the provisional curing UV lamps 503a to 503d and the full curing UV lamp 601 fully cure the ink on the non-penetrable medium p while the carriage 20 only moves along direction A. Therefore, after the medium collection mechanism 30 collects the non-penetrable medium p into the medium collection box 206, the carriage can move to the initial position along direction B at a higher speed than the moving speed along direction A. This improves work efficiency and productivity. Moreover, the second embodiment has a simpler configuration than that of the first embodiment. Furthermore, the operation of the carriage 20 is simpler in the second embodiment than in the first embodiment.

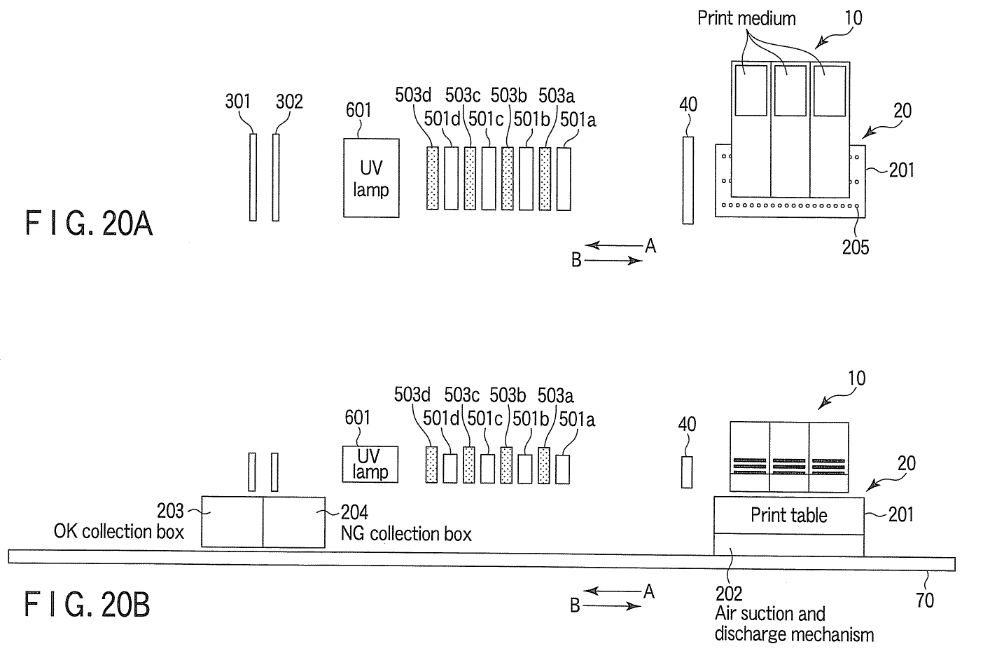

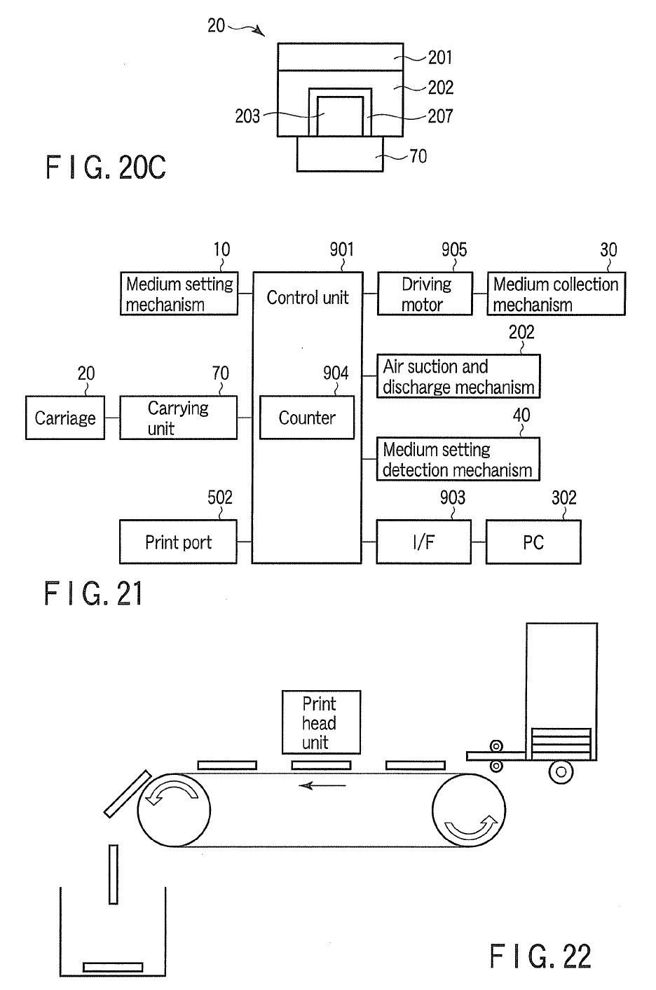

FIG. 20A is a schematic view showing an ink jet printing apparatus 1 according to a third embodiment as viewed from above. FIG. 20B is a schematic view showing the ink jet printing apparatus 1 according to the third embodiment as viewed from the front. FIG. 20C is a side view of the ink jet printing apparatus 1 according to the third embodiment.

In the third embodiment, a first medium collection mechanism 301 and a second medium collection mechanism 302 are provided downstream from the full curing UV lamp 601 along direction A. The first medium collection mechanism 301 is provided at a farther position from the full curing UV lamp 601 than the second medium collection mechanism 302 is. The first medium collection mechanism 301 and the second medium collection mechanism 302 have the same configuration as the medium collection mechanism 30 described in the first embodiment.

The first medium collection box 203 is provided at a position on the carrying unit 70 facing the first medium collection mechanism 301. The second medium collection box 204 is provided at a position on the carrying unit 70 facing the second medium collection mechanism 302. In the third embodiment, the first medium collection box 203 and second medium collection box 204 are not provided in the carriage 20, unlike the first embodiment.

The printing by the printing unit 50 to the non-penetrable medium p placed on the carriage 20 and the irradiation by the full curing UV lamp 601 are the same as in the first embodiment. A groove 207 is provided in the carriage 20 along direction A so that the carriage 20 is not obstructed by the first medium collection box 203 and the second medium collection box 204 when the carriage 20 passes the position where the first medium collection box 203 and the second medium collection box 204 are provided.

In the third embodiment, the carriage 20 passes the position where the full curing UV lamp 601 is provided, along direction A, and then moves further toward the position where the second medium collection mechanism 302 is provided. At this point, the non-penetrable medium p set on the print table 201 by the medium setting mechanism is placed on the print table 201 irrespective of whether printing is normally carried out by the printing unit 50 or not.

Now, a case where the medium setting detection mechanism 40 determines that the non-penetrable medium p is not placed at a predetermined position on the print table 201 will be described. The printing unit 50 does not execute printing to the non-penetrable medium p on the print table 201. As the carriage 20 reaches a position upstream from the position where the second medium collection mechanism 302 is provided, along direction A, the air suction and discharge mechanism 202 stops suction. As the air suction and discharge mechanism 202 stops suction, the non-penetrable medium p is released from the print table 201. After that, as the carriage 20 moves along direction A, the second medium collection mechanism 302 regulates the non-penetrable medium p so that non-penetrable medium p does not follow the movement of the carriage 20. As the carriage 20 passes the position where the second medium collection mechanism 302 is provided, the second medium collection mechanism 302 sweeps off the non-penetrable medium p into the second medium collection box 204.

Next, a case where the medium setting detection mechanism 40 determines that the non-penetrable medium p is placed at a predetermined position on the print table 201 will be described. The printing unit 50 executes printing to the non-penetrable medium p on the print table 201.

Even when the carriage 20 reaches a position upstream from the position where the second medium collection mechanism 302 is provided, along direction A, the air suction and discharge mechanism 202 continues suction. The non-penetrable medium p remains sucked to the print table 201. Therefore, even when the carriage 20 passes the position where the second medium collection mechanism 302 is provided, along direction A, the second medium collection mechanism 302 cannot sweep off the non-penetrable medium p into the second medium collection box 204.

As the carriage 20 reaches a position upstream from the position where the first medium collection mechanism 301 is provided, along direction A, the air suction and discharge mechanism 202 stops suction. As the air suction and discharge mechanism 202 stops suction, the non-penetrable medium p is released from the print table 201. After that, as the carriage 20 moves along direction A, the first medium collection mechanism 301 regulates the non-penetrable medium p so that the non-penetrable medium p does not follow the movement of the carriage 20. As the carriage 20 passes the position where the first medium collection mechanism 301 is provided, the first medium collection mechanism 301 sweeps off the non-penetrable medium p into the first medium collection box 203.

Next, as another example of the third embodiment, a method of collecting, into the first medium collection box 203, the non-penetrable medium p on which printing is normally carried out will be described. The same operation as described above is carried out until the carriage 20 reaches a position upstream from the position where the first medium collection mechanism 301 is provided, along direction A. At this time, the air suction and discharge mechanism 202 continues suction. The non-penetrable medium p remains sucked to the print table 201. Therefore, even when the carriage 20 passes the position where the first medium collection mechanism 301 is provided, along direction A, the first medium collection mechanism 301 cannot sweep off the non-penetrable medium p into the first medium collection box 203.

After that, the carriage 20 starts moving in direction B. As the carriage 20 reaches a position upstream from the position where the first medium collection mechanism 301 is provided, along direction B, the air suction and discharge mechanism 202 stops suction. As the air suction and discharge mechanism 202 stops suction, the non-penetrable medium p is released from the print table 201. After that, as the carriage 20 moves along direction B, the first medium collection mechanism 301 regulates the non-penetrable medium p so that non-penetrable medium p does not follow the movement of the carriage 20. As the carriage 20 passes the position where the first medium collection mechanism 301 is provided, the first medium collection mechanism 301 sweeps off the non-penetrable medium p into the first medium collection box 203.

In the above configuration, it can be said that the first medium collection mechanism 301 sweeps off the non-penetrable medium p on which printing is normally carried out, into the first medium collection box 203 along direction A relatively to the movement of the carriage 20. Similarly, it can be said that the second medium collection mechanism 302 sweeps off a non-penetrable medium p that is not the non-penetrable medium p on which printing is normally carried out, into the second medium collection box 204 along direction B relatively to the movement of the carriage 20. That is, the directions of sweeping off the non-penetrable medium p by the first medium collection mechanism 301 and the second medium collection mechanism 302 are relatively different with respect to the movement of the carriage 20. Therefore, even if the first medium collection box 203 and the second medium collection box 204 are provided closely to the ink jet printing apparatus 1, the first medium collection mechanism 301 and the second medium collection mechanism 302 can securely separate and collect the non-penetrable media p. As described above, when the carriage 20 moves to the initial position from the upstream side of the second medium collection mechanism 302 along direction B, the second medium collection mechanism 302 may collect the non-penetrable medium p into the second medium collection box 204.

In the third embodiment, the ink on the non-penetrable medium p on which printing is carried out by the printing unit 50 is cured by the provisional curing UV lamps 503a to 503d and the full curing UV lamp 601 simply through the movement in direction A. The carriage 20 can move to the initial position faster in direction B than in direction A. This improves work efficiency and productivity.

What is claimed is:

1. An ink jet printing apparatus comprising:
a table which places a print medium on;
a medium setting unit which sets the print medium on the table situated at an initial position;
a switching unit which switches the print medium to a fixed state or a released state with respect to the table;
a carrying unit which carries the table;
at least one or more print heads which eject ultraviolet curable ink;
a first UV curing unit which is provided downstream from each of the print heads along a direction of carrying the table from the initial position toward the print heads and casts ultraviolet rays to provisionally cure the ultraviolet curable ink; and
a second UV curing unit which is provided downstream from the first UV curing unit provided on the most downstream side along the direction of carrying the table from the initial position toward the print heads and casts ultraviolet rays to fully cure the ultraviolet curable ink.

2. The apparatus of claim 1, comprising a detection unit which detects whether the print medium is placed at a predetermined position on the table or not,
wherein if the detection unit detects that the print medium is placed at the predetermined position on the table, the print head prints on the print medium.

3. The apparatus of claim 2, wherein the switching unit sucks air from an opening provided in the table to set the print medium in the fixed state, and discharges air to set the print medium in the released state.

4. The apparatus of claim 1, wherein the print head which ejects the ultraviolet curable ink that is the hardest to cure is provided at a position that is farthest from the second UV curing unit along a direction of carrying the table from the initial position toward the print head.

5. The apparatus of claim 2, wherein the print head which ejects the ultraviolet curable ink with the lowest chroma is provided at a position that is closest to the second UV curing unit along a direction of carrying the table from the initial position toward the print head.

6. The apparatus of claim 1, wherein the carrying unit carries the table at a slower speed when passing the position where the second curing unit is provided, than when passing the position where the first UV curing unit is provided.

7. The apparatus of claim 1, comprising a neutralizer which adheres an antistatic agent to a print surface of the print medium on the table if the medium setting unit sets the print medium on the table.

8. The apparatus of claim 2, comprising a neutralizer which adheres an antistatic agent to a print surface of the print medium before printing is carried out by the print head if the detection unit detects that the print medium is placed at the predetermined position on the table.

9. The apparatus of claim 2, comprising a first storage unit which stores the print medium on which printing is carried out by the print head, and a second storage unit which stores the print medium that is not the print medium on which printing is carried out by the print head.

10. The apparatus of claim 9, comprising a collection unit which collects the print medium on which printing is carried out by the print head into the first storage unit if the detection unit detects that the print medium is placed at the predetermined position on the table, and that collects the print medium before being carried to the position where printing is carried out by the print head into the second storage unit if the detection unit detects that the print medium is not placed at the predetermined position on the table and the print medium is in the released state from the table.

11. The apparatus of claim 10, wherein the first storage unit is provided on a stage preceding the table along a direction from the initial position toward the second UV curing unit, and the second storage unit is provided on a stage following the table, and
the collection unit is provided at a position where the collection unit slides in contact with the print medium when the table is moving, the position being between the initial position and the position where the print head is provided.

12. The apparatus of claim 11, wherein if the detection unit detects that the print medium is not placed at the predetermined position on the table, the switching unit sets the print medium in the released state from the table, upstream from the collection unit along the moving direction of the table.

13. The apparatus of claim 11, wherein if the detection unit detects that the print medium is placed at the predetermined position on the table, the switching unit keeps the print medium in the fixed state to the table, upstream from the collection unit along the moving direction of the table.

14. The apparatus of claim 13, wherein after carrying the table to a position where the table passes the position where the second UV curing unit is provided, the carrying unit carries the table along a direction from the second UV curing unit toward the initial position.

15. The apparatus of claim 14, wherein the switching unit sets the print medium in the released state from the table, upstream from the collection unit along the moving direction of the table.

16. The apparatus of claim 9, comprising:
a first collection unit which collects the print medium on which printing is carried out by the print head into the first storage unit if the detection unit detects that the print medium is placed at the predetermined position on the table and the print medium is in the released state from the table;
a second collection unit which collects the print medium before being carried to the position where printing is carried out by the print head into the second storage unit if the detection unit detects that the print medium is not placed at the predetermined position on the table and the print medium is in the released state from the table;
wherein the first collection unit is provided at a position corresponding to the first storage unit and where the first collection unit slides in contact with the print medium when the table is moving, and the second collection unit is provided at a position corresponding to the second storage unit and where the second collection unit slides in contact with the print medium when the table is moving.

17. The apparatus of claim 16, wherein if the detection unit detects that the print medium is not placed at the predetermined position on the table, the switching unit sets the print medium in the released state from the table, upstream from the second collection unit along the moving direction of the table.

18. The apparatus of claim 17, wherein if the detection unit detects that the print medium is placed at the predetermined position on the table, the switching unit keeps the print medium in the fixed state to the table, upstream from the second collection unit along the moving direction of the table.

19. The apparatus of claim 18, wherein after carrying the table to a position where the table passes the position where the first collection unit is provided, the carrying unit carries the table along a direction from the second UV curing unit toward the initial position.

20. The apparatus of claim 19, wherein the switching unit sets the print medium in the released state from the table, upstream from the first collection unit along the moving direction of the table.

21. The apparatus of claim 1, wherein the medium setting unit includes a pair of rollers, and
the carrying unit carries the table with the lapse of a predetermined time after the print medium is set on the table by the medium setting unit.

22. The apparatus of claim 1, comprising a path which guides the print medium from the medium setting unit to the table, and a speed adjustment unit provided in the path which decelerates the speed of the print medium.

23. The apparatus of claim 22, wherein the speed adjustment unit covers an inside of the path, and moves along a discharge direction if the print medium discharged form the medium setting unit collides with the speed adjustment unit.

24. The apparatus of claim 1, comprising:
a card table on which the print medium is stacked flat in a direction of height;
a medium carrying unit which carries the print medium in a bottom part of the stack on the card table to the medium setting unit; and
a card sensor which detects whether the print medium is stacked on the card table or not.
